(19) United States
(12) Patent Application Publication
(10) Pub. No.: US 2024/0107088 A1
(43) Pub. Date: Mar. 28, 2024

(54) ENCODER AND DECODER FOR VIDEO CODING FOR MACHINES (VCM)

(71) Applicants: Hari Kalva, BOCA RATON, FL (US); Borivoje Furht, BOCA RATON, FL (US); Velibor Adzic, Canton, GA (US)

(72) Inventors: Hari Kalva, BOCA RATON, FL (US); Borivoje Furht, BOCA RATON, FL (US); Velibor Adzic, Canton, GA (US)

(21) Appl. No.: 18/528,099

(22) Filed: Dec. 4, 2023

Related U.S. Application Data
(63) Continuation of application No. PCT/US22/32048, filed on Jun. 3, 2022.
(60) Provisional application No. 63/197,834, filed on Jun. 7, 2021.

(51) Int. Cl. H04N 21/235; H04N 21/234; H04N 21/2343; H04N 21/435; H04N 21/4402

(52) U.S. Cl. CPC H04N 21/2355; H04N 21/23418; H04N 21/2343; H04N 21/4355; H04N 21/4402

(57) ABSTRACT

A video coding for machines (VCM) encoder includes a first video encoder, the first video encoder configured to encode an input video into a bitstream. The VCM encoder includes a feature extractor, the feature extractor configured to detect at least a feature in the input video. The VCM encoder includes a second encoder, the second encoder configured to encode a feature bitstream as a function of the input video and at least a feature.

### CROSS REFERENCE TO RELATED APPLICATIONS

This application is a continuation of international application serial no. PCT/US2022/032048, filed on Jun. 3, 2022, and entitled ENCODER AND DECODER FOR VIDEO CODING FOR MACHINES (VCM), which claims the benefit of priority to U.S. Provisional Application Ser. No. 63/197,834, filed on Jun. 7, 2021, and entitled VIDEO CODING FOR MACHINES (VCM) ENCODER, the disclosures of each of which are hereby incorporated by reference in there entireties.

### FIELD OF THE INVENTION

The present invention generally relates to the field of video encoding and decoding. In particular, the present invention is directed to an encoder and decoder for video coding for machines (VCM).

### BACKGROUND

A video codec can include an electronic circuit or software that compresses or decompresses digital video. It can convert uncompressed video to a compressed format or vice versa. In the context of video compression, a device that compresses video (and/or performs some function thereof) can typically be called an encoder, and a device that decompresses video (and/or performs some function thereof) can be called a decoder.

A format of the compressed data can conform to a standard video compression specification. The compression can be lossy in that the compressed video lacks some information present in the original video. A consequence of this can include that decompressed video can have lower quality than the original uncompressed video because there is insufficient information to accurately reconstruct the original video.

There can be complex relationships between the video quality, the amount of data used to represent the video (e.g., determined by the bit rate), the complexity of the encoding and decoding algorithms, sensitivity to data losses and errors, ease of editing, random access, end-to-end delay (e.g., latency), and the like.

Motion compensation can include an approach to predict a video frame or a portion thereof given a reference frame, such as previous and/or future frames, by accounting for motion of the camera and/or objects in the video. It can be employed in the encoding and decoding of video data for video compression, for example in the encoding and decoding using the Motion Picture Experts Group (MPEG)'s advanced video coding (AVC) standard (also referred to as H.264). Motion compensation can describe a picture in terms of the transformation of a reference picture to the current picture. The reference picture can be previous in time when compared to the current picture, from the future when compared to the current picture. When images can be accurately synthesized from previously transmitted and/or stored images, compression efficiency can be improved.

Video was traditionally a media for human consumption and video compression methodologies focused on maintaining the fidelity of the video perceived by a human viewer after decompression. Today, however, vast quantities of video are being analyzed by machines. As such, there is a growing need to develop and optimize video compression methods optimized for machine analysis. Depending on application, a machine may not need the same information from the video content to perform an analysis and function. Instead, certain features in the video signal may be sufficient. Video coding for machines (“VCM”) is an approach to generating a compressed bitstream by compressing both the traditional video stream as well as features extracted therefrom that are well suited for machine analysis.

### SUMMARY OF THE DISCLOSURE

A system for video coding for machines (VCM) including an encoder and a decoder is provided. The VCM encoder includes a first video encoder that is preferably configured to encode an input video signal into a bitstream. The VCM encoder further includes a feature extractor which is configured to detect at least one feature in the input video. A second encoder is configured to encode a feature bitstream as a function of the input video and at least a feature.

In some embodiments the video decoder is coupled to the feature extractor to receive a feature signal therefrom. Preferably, a machine model can be included in, or provided to, the feature extractor. A multiplexor can be provided to combine the encoded video and feature signals into a bitstream for transmission to a decoder.

In some preferred embodiments the feature extractor further comprises a machine-learning model configured to output at least a feature map. Still preferably, the machine-learning model can further comprise a convolutional neural network. In some embodiments, the convolutional neural network includes a plurality of convolutional layers and a plurality of pooling layers.

The feature extractor may further include a classifier configured to classify an output of the machine-learning model to at least a feature. In certain embodiments, the classifier is a deep neural network.

The feature extractor may be configured to generate a plurality of feature maps and spatially arrange at least a portion of the plurality of feature maps prior to encoding. The feature maps may be spatially arranged based on parameters of the feature maps, such as texture.

In yet another embodiment, the second encoder can be further configured to group feature maps according to a classification of at least one feature.

A VCM decoder is configured to receive an encoded hybrid bitstream. The VCM decoder includes a demultiplexor receiving the hybrid bitstream and providing a video bitstream and a feature bitstream therefrom. A feature decoder is provided. The feature decoder receives an encoded feature bitstream from the demultiplexor and provides a decoded set of features for machine processing. A machine model is preferably coupled to the feature decoder. A video decoder is provided to receive the encoded video bitstream from the demultiplexor and provide a decoded video signal suitable for human consumption.

In some embodiments, the VCM decoder can be configured to receive a bitstream comprising a plurality of spatially arranged feature maps, decode the spatially arranged feature maps, and reconstruct the original sequence of feature maps.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a simplified block diagram illustrating an exemplary embodiment of a VCM encoder and decoder system;

FIG. 2 is a simplified block diagram illustrating an exemplary embodiment of a VCM encoder and decoder system;

FIG. 3 is a schematic diagram pictorially illustrating an exemplary embodiment of a machine model;

FIG. 4 is a diagram illustrating an exemplary embodiment of a process for assembly of convolutional units;

FIG. 5 is a block diagram illustrating an exemplary embodiment of a video in coding unit and convolutional unit representations;

FIG. 6 is a block diagram illustrating an exemplary embodiment of an inter prediction process;

FIG. 7 is a block diagram illustrating an exemplary embodiment of an intra prediction process;

FIG. 8 is a schematic diagram illustrating an exemplary embodiment of a video input picture and corresponding convolutional layers;

FIG. 9 is a simplified block diagram illustrating an exemplary embodiment of a video decoder;

FIG. 10 is a block diagram illustrating an exemplary embodiment of a video encoder;

FIG. 11 is a block diagram illustrating an exemplary embodiment of a machine-learning module; and

FIG. 12 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

In embodiments, a VCM encoder may be capable of operating in either video or hybrid mode. In either mode, VCM encoder may provide a video bitstream to be decoded as an output video to be viewed by a person.

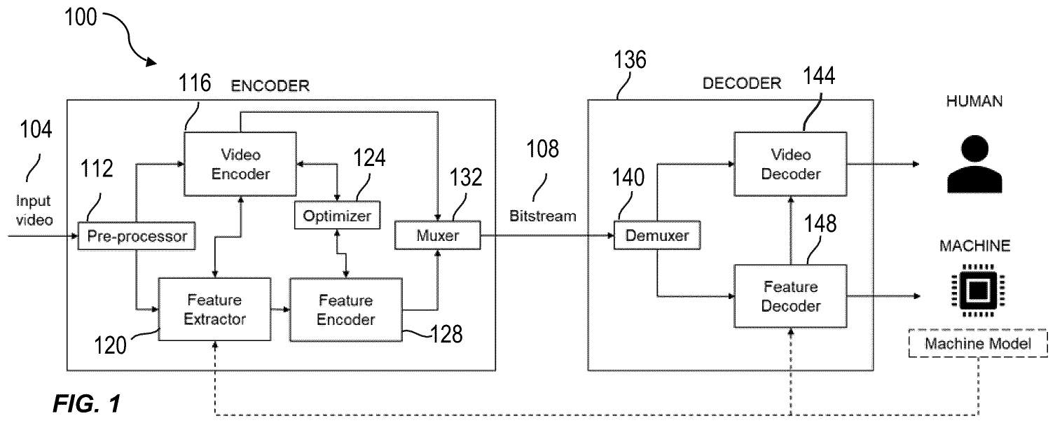

Referring now to FIG. 1, an exemplary embodiment of encoder for video coding for machines (VCM) is illustrated. VCM encoder 100 may be implemented using any circuitry including without limitation digital and/or analog circuitry. VCM encoder 100 may be configured using hardware configuration, software configuration, firmware configuration, and/or any combination thereof. VCM encoder 100 may be implemented as a computing device and/or as a component of a computing device, which may include without limitation any computing device as described below. In an embodiment, VCM encoder 100 may be configured to receive an input video 104 and generate an output bitstream 108. Reception of an input video 104 may be accomplished in any manner described below. A bitstream may include, without limitation, any bitstream as described below. VCM encoder 100 may include, without limitation, a pre-processor 112, a video encoder 116, a feature extractor 120, an optimizer 124, a feature encoder 128, and/or a multiplexor 132. Pre-processor 112 may receive input video 104 stream and parse out video, audio and metadata sub-streams of the stream. Pre-processor 112 may include and/or communicate with decoder as described in further detail below. In other words, pre-processor 112 may have an ability to decode input streams. This may allow, in a non-limiting example, decoding of an input video 104, which may facilitate downstream pixel-domain analysis.

Further referring to FIG. 1, VCM encoder 100 may operate in a hybrid mode and/or in a video mode. When in the hybrid mode, VCM encoder 100 may be configured to encode a visual signal that is intended for human consumers and encode a feature signal that is intended for machine consumers. Machine consumers may include, without limitation, any devices and/or components, including without limitation computing devices as described in further detail below. Input signal may be passed, for instance when in hybrid mode, through pre-processor 112.

Still referring to FIG. 1, video encoder 116, which is encoding the video signal for human consumption, may include without limitation any video encoder 116 as described in further detail below. When VCM encoder 100 is in hybrid mode, VCM encoder 100 may send unmodified input video 104 to video encoder 116 and a copy of the same input video 104, and/or input video 104 that has been modified in some way, to feature extractor 120. Modifications to input video 104 may include any scaling, transforming, or other modification that may occur to persons skilled in the art upon reviewing the entirety of this disclosure. For instance, and without limitation, input video 104 may be resized to a smaller resolution, a certain number of pictures in a sequence of pictures in input video 104 may be discarded, reducing framerate of the input video 104, color information may be modified, for example and without limitation by converting an RGB video might be converted to a grayscale video, or the like.

Still referring to FIG. 1, video encoder 116 and feature extractor 120 are connected and might exchange useful information in both directions. For example, and without limitation, video encoder 116 may transfer motion estimation information to feature extractor 120, and vice-versa. Video encoder 116 may provide Quantization mapping and/or data descriptive thereof based on regions of interest (ROI), which video encoder 116 and/or feature extractor 120 may identify, to feature extractor 120, or vice-versa. Video encoder 116 may provide to feature extractor 120 data describing one or more partitioning decisions based on features present and/or identified in input video 104, input signal, and/or any frame and/or subframe thereof; feature extractor 120 may provide to video encoder 116 data describing one or more partitioning decisions based on features present and/or identified in input video 104, input signal, and/or any frame and/or subframe thereof. Video encoder 116 feature extractor 120 may share and/or transmit to one another temporal information for optimal group of pictures (GOP) decisions. Each of these techniques and/or processes may be performed, without limitation, as described in further detail below.

With continued reference to FIG. 1, feature extractor 120 may operate in an offline mode or in an online mode. Feature extractor 120 may identify and/or otherwise act on and/or manipulate features. A “feature,” as used in this disclosure, is a specific structural and/or content attribute of data. Examples of features may include scale invariant feature transforms (SIFT), audio features, color hist, motion hist, speech level, loudness level, or the like. Features may be time stamped. Each feature may be associated with a single frame of a group of frames. Features may include high level content features such as timestamps, labels for persons and objects in the video, coordinates for objects and/or regions-of-interest, frame masks for region-based quantization, and/or any other feature that may occur to persons skilled in the art upon reviewing the entirety of this disclosure. As a further non-limiting example, features may include features that describe spatial and/or temporal characteristics of a frame or group of frames. Examples of features that describe spatial and/or temporal characteristics may include motion, texture, color, brightness, edge count, blur, blockiness, or the like. When in offline mode, all machine models as described in further detail below may be stored at encoder and/or in memory of and/or accessible to encoder. Examples of such models may include, without limitation, whole or partial convolutional neural networks, keypoint extractors, edge detectors, salience map constructors, or the like. When in online mode one or more models may be communicated to feature extractor 120 by a remote machine in real time or at some point before extraction.

Still referring to FIG. 1, feature encoder 128 is configured for encoding a feature signal, for instance and without limitation as generated by feature extractor 120. In an embodiment, after extracting the features, feature extractor 120 may pass extracted features to feature encoder 128.

Feature encoder 128 may use entropy coding and/or similar techniques, for instance and without limitation as described below, to produce a feature stream, which may be passed to multiplexor 132.

Video encoder 116 and/or feature encoder 128 may be connected via optimizer 124; optimizer 124 may exchange useful information between the video encoder 116 and feature encoder 128. For example, and without limitation, information related to codeword construction and/or length for entropy coding may be exchanged and reused, via optimizer 124, for optimal compression.

In an embodiment, and continuing to refer to FIG. 1, video encoder 116 may produce a video stream; video stream may be passed to multiplexor 132. Multiplexor 132 may multiplex video stream with a feature stream generated by feature encoder 128. Alternatively or additionally, video and feature bitstreams may be transmitted over distinct channels, distinct networks, to distinct devices, and/or at distinct times or time intervals (time multiplexing). Each of the video stream and feature stream may be implemented in any manner suitable for implementation of any bitstream as described in this disclosure. In an embodiment, multiplexed video stream and feature stream may produce a hybrid bitstream, which may be transmitted as described in further detail below.

Still referring to FIG. 1, where VCM encoder 100 is in video mode, VCM encoder 100 may use video encoder 116 for both video and feature encoding. Feature extractor 120 may transmit features to video encoder 116; the video encoder 116 may encode features into a video stream that may be decoded by a corresponding video decoder 144. It should be noted that VCM encoder 100 may use a single video encoder 116 for both video encoding and feature encoding, in which case it may use different set of parameters for video and features; alternatively, VCM encoder 100 may two separate video encoder 116s, which may operate in parallel.

Still referring to FIG. 1, system 100 may include and/or communicate with, a VCM decoder 136. VCM decoder 136 and/or elements thereof may be implemented using any circuitry and/or type of configuration suitable for configuration of VCM encoder 100 as described above. VCM decoder 136 may include, without limitation, a demultiplexor 140. Demultiplexor 140 may operate to demultiplex bitstreams if multiplexed as described above. For instance and without limitation, demultiplexor 140 may separate a multiplexed bitstream containing one or more video bitstreams and one or more feature bitstreams into separate video and feature bitstreams.

Continuing to refer to FIG. 1, VCM decoder 136 may include a video decoder 144. Video decoder 144 may be implemented, without limitation, in any manner suitable for a decoder as described in further detail below. In an embodiment, and without limitation, video decoder 144 may generate an output video, which may be viewed by a human or other creature and/or device having visual sensory abilities.

Still referring to FIG. 1, VCM decoder 136 may include a feature decoder 148. In an embodiment, and without limitation, feature decoder 148 may be configured to provide one or more decoded data to a machine. Machine may include, without limitation, any computing device, including without limitation any microcontroller, processor, embedded system, system on a chip, network node, or the like. Machine may operate, store, train, receive input from, produce output for, and/or otherwise interact with a machine model as described in further detail below. Machine may be included in an Internet of Things (IOT), defined as a network of objects having processing and communication components, some of which may not be conventional computing devices such as desktop computers, laptop computers, and/or mobile devices. Objects in IoT may include, without limitation, any devices with an embedded microprocessor and/or microcontroller and one or more components for interfacing with a local area network (LAN) and/or wide-area network (WAN); one or more components may include, without limitation, a wireless transceiver, for instance communicating in the 2.4-2.485 GHz range, like BLUETOOTH transceivers following protocols as promulgated by Bluetooth SIG, Inc. of Kirkland, Wash, and/or network communication components operating according to the MODBUS protocol promulgated by Schneider Electric SE of Rueil-Malmaison, France and/or the ZIGBEE specification of the IEEE 802.15.4 standard promulgated by the Institute of Electronic and Electrical Engineers (IEEE). Persons skilled in the art, upon reviewing the entirety of this disclosure, will be aware of various alternative or additional communication protocols and devices supporting such protocols that may be employed consistently with this disclosure, each of which is contemplated as within the scope of this disclosure.

With continued reference to FIG. 1, each of VCM encoder 100 and/or VCM decoder 136 may be designed and/or configured to perform any method, method step, or sequence of method steps in any embodiment described in this disclosure, in any order and with any degree of repetition. For instance, each of VCM encoder 100 and/or VCM decoder 136 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Each of VCM encoder 100 and/or VCM decoder 136 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

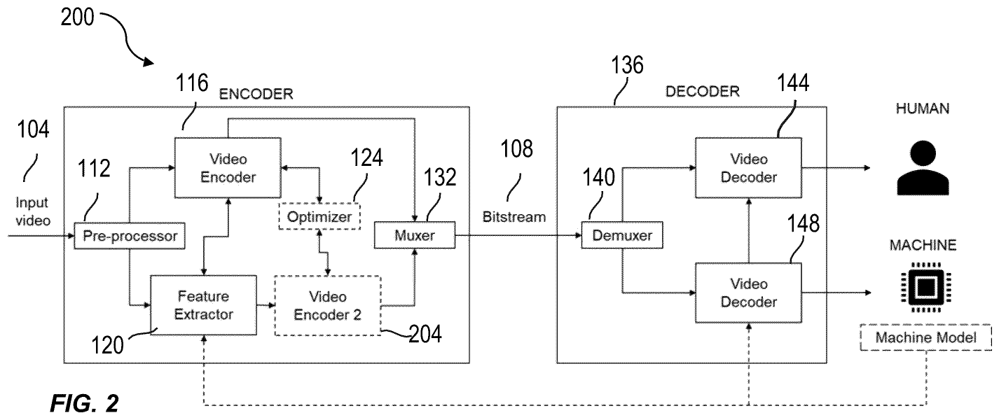

Referring now to FIG. 2, an exemplary embodiment 200 of a VCM encoder 100 operating in video mode is illustrated. VCM encoder 100 may be configured to switch between video mode and hybrid mode upon receiving an instruction from a user, a program, a memory location, and/or one or more additional devices (not shown) interacting with VCM encoder 100. In video mode, VCM encoder 100 may be configured to operate a second video encoder 204.

Second video encoder 204 may encode features and/or a second video bitstream in any manner suitable for feature encoder 128 and/or video encoder 116 as described above. Second video encoder 204 may receive data from and/or transmit data to feature extractor 120 and/or optimizer 124. With continued reference to FIG. 2, video mode may be used for encoding any or all types of features that may be represented as visual information. As a non-limiting example, video mode may be used to encode salience maps, filtered images such as images representing edges, lines or the like, feature maps of convolutional neural networks as described in further detail below, or the like.

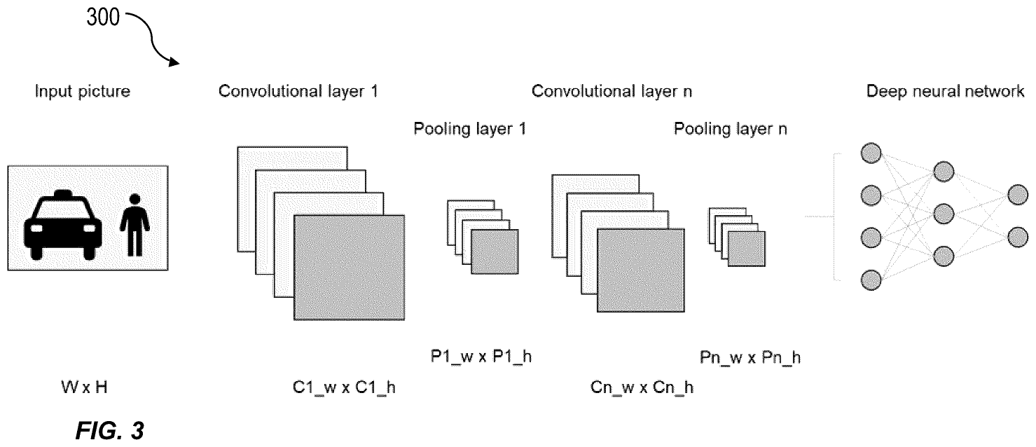

Referring now to FIG. 3, an exemplary embodiment 300 of a convolutional neural network (CNN) for use with VCM encoder 100 is illustrated. As used in this disclosure, a “neural network,” also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes, one or more intermediate layers, and an output layer of nodes. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 3, a node may include, without limitation, a plurality of inputs xi that may receive numerical values from inputs to a neural network containing the node and/or from other nodes. Node may perform a weighted sum of inputs using weights wi that are multiplied by respective inputs xi. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wi applied to an input xi may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wi may be determined by training a neural network using training data, which may be performed using any suitable process as described above. In an embodiment, and without limitation, a neural network may receive semantic units as inputs and output vectors representing such semantic units according to weights wi that are derived using machine-learning processes as described in this disclosure. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like. CNN may include, without limitation, a deep neural network (DNN) extension, where a DNN is defined as a neural network with two or more hidden layers.

In an embodiment, continuing to refer to FIG. 3, CNN and/or other models may be used for encoding, adjusted and/or rearranging feature maps to fit with a standard video encoder 116 requirements for the input pictures. In an exemplary embodiment, an input image of width W and height H may be input to CNN and/or other models. Through a series of operations known as convolutions and pooling, an image in the input picture may be transformed into one or more feature maps. Each layer of a CNN as output may include several feature maps. There may be a total of n convolutional (C) and pooling (P) layers. Each layer may have the same or different dimensions of the convolutional and pooling kernel represented as width w and height h; for instance, convolutional layer 1 may have width C1_w and height C1_h, pooling layer 1 may have width P1_w and height P1_h, convolutional layer 2 may have width C2_w and height C2_h, pooling layer 2 may have width P2_w and height P2_h, and so forth.

In some embodiments, and still referring to FIG. 3, after a final pooling operation, an output vector may be passed to a classifier, such as without limitation a deep neural network, which may be used for classification of input vectors. As used in this disclosure, a “classification algorithm” is a machine learning algorithm and/or process as described in further detail below, which sorts inputs into categories or bins of data, outputting the categories or bins of data and/or labels associated therewith; a “classifier,” as used in this disclosure is a machine-learning model, such as a mathematical model, neural net, or program generated by machine-learning processes as described in further detail below. A classifier may be configured to output at least a datum that labels or otherwise identifies a set of data that are clustered together, found to be close under a distance metric as described below, or the like. A computing device and/or another device may generate a classifier using a classification algorithm, defined as a process whereby a computing device derives a classifier from training data. In addition to neural network classifiers such as DNN classifiers, classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers.

In an embodiment, and still referring to FIG. 3, a combination of values of output neurons may be used by VCM encoder 100 to determine a presence or absence of a certain class of interest. For example, a neural network with two outputs may be trained to output combination [0, 1] if person is detected and [1, 0] if car is detected, or the like. Because convolution and pooling as output may have 2-dimensional matrix of values, such 2-dimensional matrix of values may be represented as a visual picture. This picture may also be referred to as a “feature map.” In some implementations, and without limitation, a VCM encoder 100 may contain a complete CNN, in which case output of feature extractor 120 may include either a final, pooled vector or an output of a DNN's middle, or last layers. In other implementations, a VCM encoder 100 may contain just part of a CNN. For example VCM encoder 100 may contain a first k layers of CNN, which may be denoted C1, P1, C2, P2, . . . , Ck, Pk, where k may include be any integer number between 1 and n−1, inclusive. In this case an output of feature extractor 120 may include a set of feature maps from a final layer (k). In some embodiments, if an output of a feature extractor 120 includes a set of feature maps from convolutional and/or pooling layers, that output may be encoded using video encoder 116. Before sending feature maps set to video encoder 116, a feature extractor 120 may adapt and/or rearrange each feature map, making it suitable as an input to the video encoder 116. Since feature maps are usually much smaller than a typical picture size that is used by a video encoder 116, one way of rearranging a set of feature maps may include assembly thereof into a larger rectangular unit that is suitable for video encoding.

Still referring to FIG. 3, CNN, DNN, and/or any other model and/or process used for feature rearrangement and/or mapping may be trained using any machine-learning process as described in further detail below.

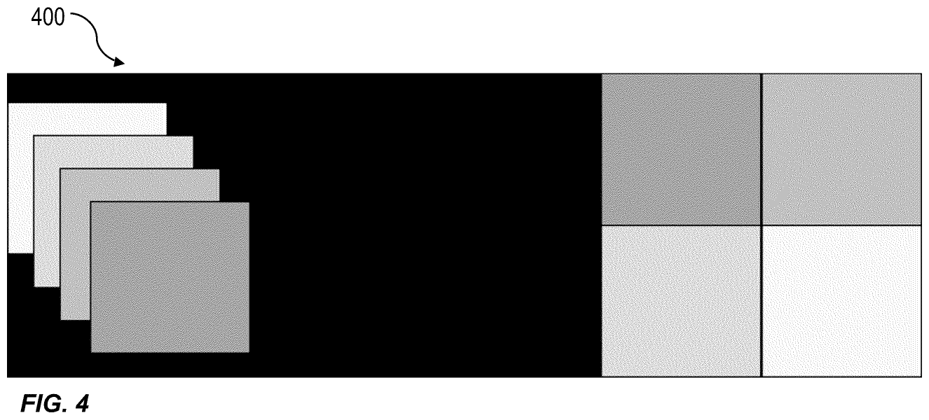

Referring now to FIG. 4, an exemplary embodiment of a process 400 for spatial reassembly is illustrated. In an embodiment, a set of feature maps from a convolutional layer and/or other layer and/or element described herein may be arranged into a rectangular unit; unit may alternatively or additionally have any other suitable shape, including a combination of rectangular forms into slices and/or tiles, and/or any shape having a polygonal and/or curved perimeter. One such shape may surround another such shape forming a donut-like or other enclosure thereof. A spatial position of individual maps may be determined by a simple sequential arrangement where maps are positioned in a quadrant that corresponds to their sequential order in a convolution operation. Spatial position of maps in a unit may alternatively or additionally be arranged so that a resulting video coding is optimized. One example of an operation that may be applied for such optimization is placement of maps with similar texture next to each other, hence increasing efficacy of intra prediction by a video encoder 116, for instance and without limitation as described below. A measure of texture may be expressed as a variance of pixel values in a map. Furthermore, feature units that are assembled from a single convolution layer may be combined with feature units from other convolutional layers in either spatial or temporal manner.

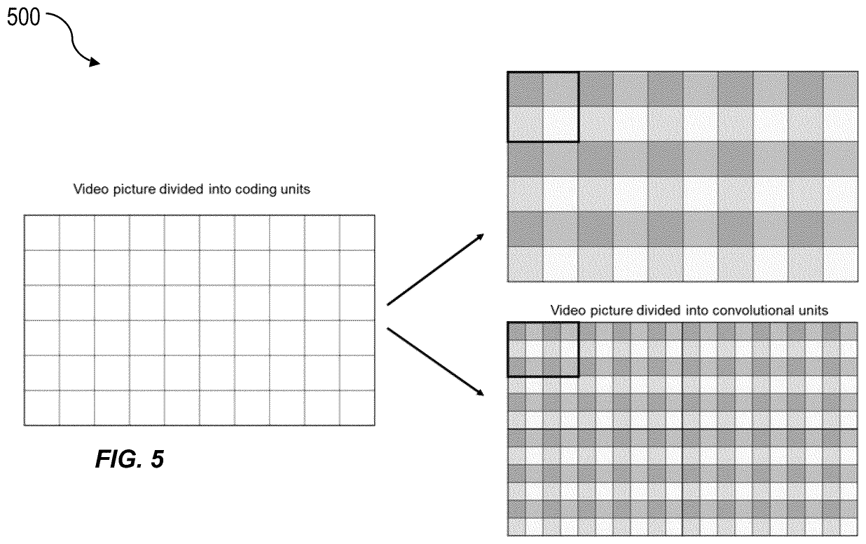

Referring now to FIG. 5, an exemplary embodiment of a set of picture maps assembled from units, defined as arranged outputs as generated in FIG. 4, is illustrated. As a non-limiting example, convolutional units may be assembled as neighboring blocks inside a picture that is encoded by video encoder 116. Note that in some instances it may be beneficial to align unit boundaries with boundaries of coding units of video encoder 116. This may be achieved, without limitation, either by using convolutional kernels of a matching size with coding units (for example 64×64 pixels, or 128×128 pixels), or by rescaling convolutional units to match a coding unit size. Rescaling may be achieved using a simple linear or bicubic rescaling technique applied to pixels of the convolutional unit.

Still referring to FIG. 5, a single coding unit of a picture may contain one or more convolutional units, for instance as depicted in the bottom right of FIG. 5. A spatial position of a convolutional unit in a particular arrangement may be calculated, without limitation, either based on a sequential order of convolutional units, or by using optimizing algorithms that place units with similar characteristics, such as texture, in proximity Besides an improvement in intra prediction of video coding, temporal mapping to spatial positions may be considered as well, since video encoder 116 may apply temporal prediction and/or inter prediction on units as well.

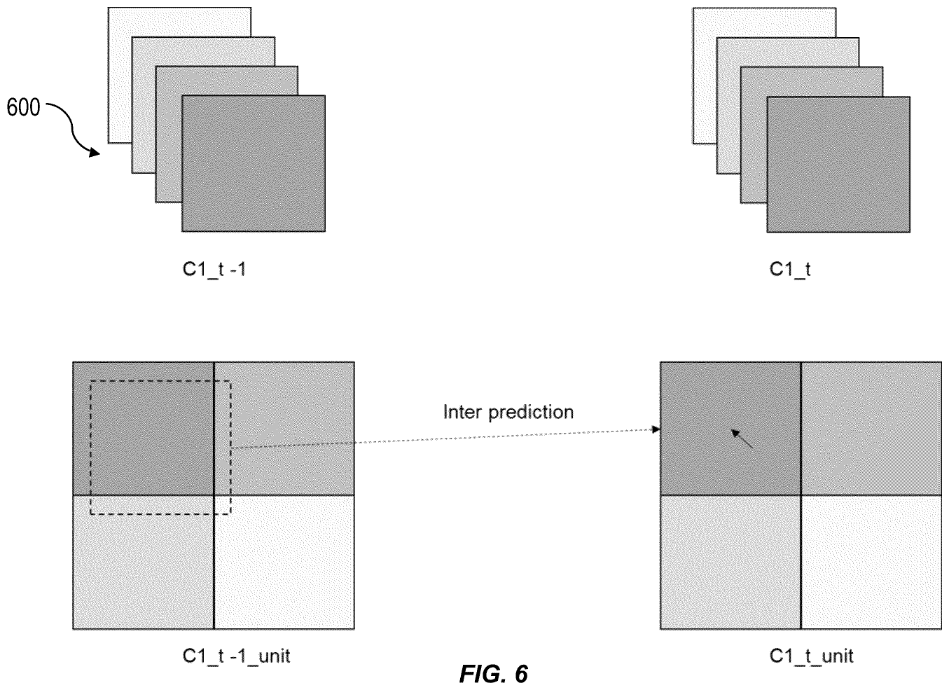

Referring now to FIG. 6, a depiction of an exemplary embodiment of inter prediction that is calculated using motion estimation, and results in a motion vector (MV) illustrated. Since a homogeneity of convolutional maps, and hence similarities of units in consecutive pictures, depend on a change in an input video 104, video encoder 116 may apply dynamic resolution change to achieve optimal compression. For example, video encoder 116 may reduce a resolution of pictures when relevant convolutional maps decrease in number. This may occur in a case when an input video 104 switches from a scene that contains many objects and regions of interest to a scene with one object and/or a smaller region of interest. In such cases a number of convolutional units may be reduced; as a result, it may be beneficial to reduce a resolution of a coding picture. A change in resolution may be signaled to the decoder in any manner that may occur to persons skilled in the art upon reviewing the entirety of this disclosure, including without limitation, using header information. Other appropriate information and/parameters related to the convolutional maps may be encoded using a supplemental enhancement information (SEI) stream, or other similar metadata stream. A metadata stream such as SEI may be used to encode relevant information describing a machine model as well.

Still referring to FIG. 6, while an optimal performance of video encoder 116 may be guaranteed for given input pictures by rate-distortion optimization (RDO), which may be inherent in most standard encoders, some parameters may be adjusted and updated by the feature extractor 120. A reason for this adjustment may include the fact that video encoder 116 may be optimized for visual quality of an encoded video, while a utility function of a machine might deviate from that measure in certain cases. For example, and without limitation, feature maps that are associated with significant values of weights in a CNN might be signaled as more important, and in that sense a compression for them by a video encoder 116 may need to be adjusted. One non-limiting example of such function may be to update a quantization level of an encoder to be inversely proportional to a magnitude of weight(s) associated with a given convolutional unit. Magnitude of weights may be expressed as a relative value compared to all weights in a CNN.

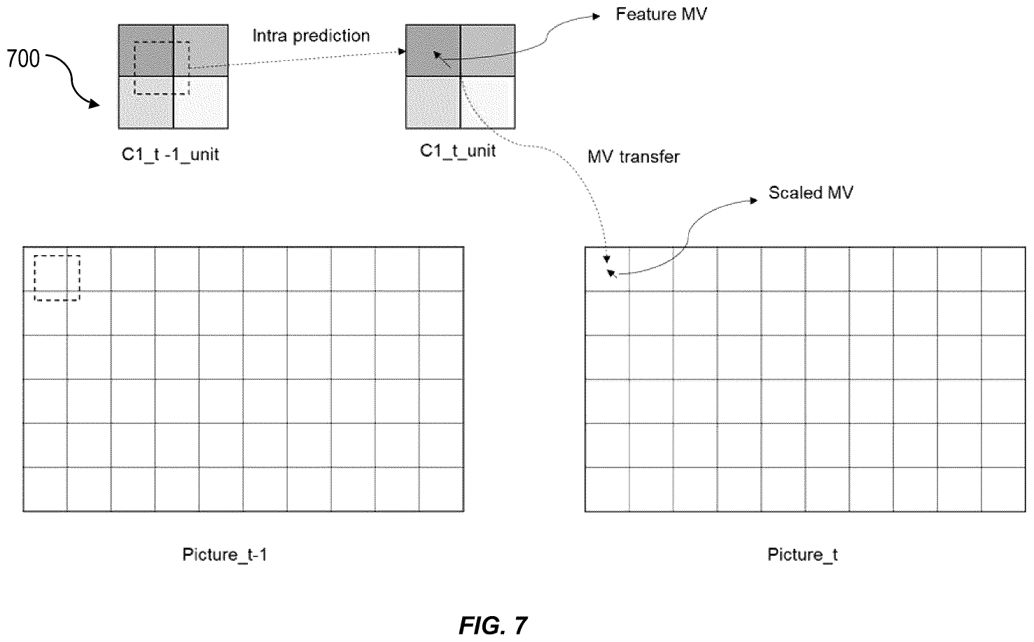

Referring now to FIG. 7, an exemplary embodiment of a process for motion vector mapping is illustrated. In an embodiment, motion vector mapping may include and/or be driven by interaction between feature extractor 120 and video encoder 116; this interaction may take place in hybrid mode and/or video mode. In an embodiment, motion estimation information may be transferred from feature extractor 120 to video encoder 116 and/or from video encoder 116 to feature extractor 120. In the case of an input video 104 that has temporal dependency, where consecutive pictures represent some real-world movement, motion may be estimated using inter prediction, utilizing motion estimation. Resulting motion vectors (MV) may represent displacement of prediction units between consecutive frames.

As an example, and with continued reference to FIG. 7, simple translational motion may be described using a motion vector (MV) with two components MVx, MVy that describe displacement of blocks, coding units, coding tree units, convolutional units, and/or pixels in a current frame and/or from one frame to the next. More complex motion such as rotation, zooming, and/or warping may be described using affine motion vector, where an “affine motion vector,” as used in this disclosure, is a vector describing a uniform displacement of a set of pixels or points represented in a video picture and/or picture, such as a set of pixels illustrating an object moving across a view in a video without changing apparent shape during motion. Some approaches to video encoding and/or decoding may use 4-parameter or 6-parameter affine models for motion compensation in inter picture coding.

For example, and still referring to FIG. 7, a six-parameter affine motion can be described as:

x′=ax+by+cy′32 dx+ey+f

And a four-parameter affine motion can be described as:

x′=ax+by+cy′=−bx+ay+f

where (x,y) and (x′,y′) are pixel locations in current and reference pictures, respectively; a, b, c, d, e, and f are the parameters of the affine motion model.

Still referring to FIG. 7, and as described above motion estimation may be conducted on convolutional units and/or more generally on feature maps. In the case of video mode this estimation may be performed by a video encoder 116. However, in some instances fast and simple motion estimation may be implemented in feature extractor 120 itself, thus allowing removal of temporal dependencies between feature maps, before sending them to feature encoder 128. Motion information obtained in this way may be re-used by video encoder 116 for encoding input video 104. Since motion estimation on lower resolution feature maps may be much more efficient, this may significantly reduce the complexity of the video encoder 116. In other words, feature maps may be generated as described above, motion vectors may be derived from feature maps, and motion vectors may be signaled to video encoder 116. Video encoder 116 may use motion vectors so signaled to encode video bitstream, for instance and without limitation as described below.

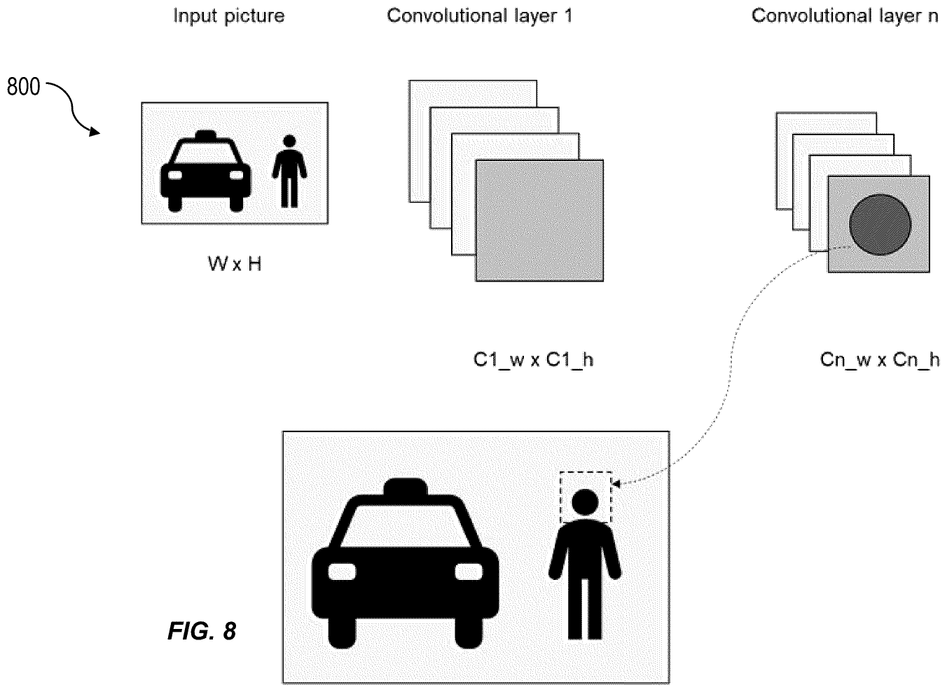

In some cases, and still referring to FIG. 7, motion vector mapping may be calculated by video encoder 116, and transferred to feature extractor 120. This may be done to increase precision of motion vectors in a feature modality. Motion vectors may be transferred between modalities, such as between feature and video modalities, by applying appropriate scaling constant that is proportional to a difference in resolution of a convolutional unit and picture prediction unit. Referring now to FIG. 8, an exemplary embodiment of a process for quantization mapping based on ROIs, which may be mapped from features to video, is illustrated. In an embodiment, video encoder 116 may apply quantization to a coding unit based on an RDO to maximize visual quality of the coding unit for a given bit budget. In some cases, certain parts of a picture may be perceptually more significant than others, and may be coded with higher quality, while a remainder of the picture may be coded with somewhat lower quality. Examples of perceptually significant parts are the ones that contain human faces, objects, low texture, or the like. Significance of parts of a picture may be determined by a utility function as well. For example, in a surveillance video it may be most important to preserve details on faces and small objects of interest. Using information obtained by feature extractor 120, it may be possible to designate such parts of a picture. This may be done using regions of interest that may be represented as bounding boxes; bounding boxes may be defined in any suitable manner, including without limitation coordinates x, y of a location within a picture and/or feature map, such as top left corner thereof, and width and height, w, h, as expressed in pixel values. This spatial information may be passed to video encoder 116 which may assign lower distortion and higher rate in an RDO calculation for all coding units within a ROI.

Further referring to FIG. 8, significance may be determined, stored, and/or signaled according to a significance coefficient SN, which may be supplied by an outside expert and/or calculated based on characteristics of an area in a picture such as without limitation are defined as a convolutional unit, a coding unit, a coding tree unit, or the like. A “characteristic” of an area, as used herein, is a measurable attribute of the area that is determined based upon its contents; a characteristic may be represented numerically using an output of one or more computations performed on first area. One or more computations may include any analysis of any signal represented by first area. One non-limiting example may include assigning higher SN for an area with a smooth background and a lower SN for an area with a less smooth background in quality modeling applications; as a non-limiting example, smoothness may be determined using Canny edge detection to determine a number of edges, where a lower number indicates a greater degree of smoothness. A further example of automatic smoothness detection may include use of fast Fourier transforms (FFT) over a signal in spatial variables over an area, where signal may be analyzed over any two-dimensional coordinate system, and over channels representing red-green-blue color values or the like; greater relative predominance in a frequency domain, as computed using an FFT, of lower frequency components may indicate a greater degree of smoothness, whereas greater relative predominance of higher frequencies may indicate more frequent and rapid transitions in color and/or shade values over background area, which may result in a lower smoothness score; semantically important objects may be identified by user input. Semantic importance may alternatively or additionally be detected according to edge configuration, and/or texture pattern. A background may be identified, without limitation, by receiving and/or detecting a portion of an area that represents significant or “foreground” object such as a face or other item, including without limitation a semantically important object. Another example can include assigning higher SN for the areas containing semantically important objects, such as human face.

In an exemplary embodiment, and still referring to FIG. 8, a CNN or other element described in this disclosure may detect a face in a layer Cn, in a first feature map. A corresponding bounding box may be mapped to a picture that is encoded by video encoder 116. A designated coding unit may be assigned higher priority and coded with an appropriate RDO update. In other examples, derivation may be performed from other feature models, such as keypoint extractors, edge detectors, salience map constructors, or the like.

With continued reference to FIG. 8, VCM encoder 100 may perform partitioning decisions based on features, for instance and without limitation, using information provided from feature extractor 120 to video encoder 116. In an embodiment, video encoder 116 may use pertinent information received from feature extractor 120 to update other encoding parameters, such as partitioning. For example, and without limitation, a depth of a coding unit tree may be increased for units within a region of interest, such as without limitation a bounding box. In another example, video encoder 116 may align a size of a smallest coding unit to a size of a relevant bounding box to preserve as much detail as possible and avoid distortions that are introduced on block boundaries between prediction units.

Still referring to FIG. 8, information transmitted from feature extractor 120 to video encoder 116 or vice-versa may include temporal information. In a non-limiting example, a feature extractor 120 may be used to detect significant changes in an input video 104, such as without limitation a scene change, and signal a timestamp to video encoder 116; video encoder 116 may use this information to optimally decide on a structure and length of one or more groups of pictures (GOPs). Key-frames, or in other words intra coded frames, may correspond to a first picture of a scene, in a non-limiting example. In an embodiment, variability of consecutive pictures may determine an optimal type of frames used in a GOP, between intra (I), and inter (P, B), as well as a number and/or sequence of such frames. On the other hand, information obtained by video encoder 116 may be used by feature extractor 120, for instance where the latter does not contain motion estimation. In such cases, motion estimation of video encoder 116 may be used to improve motion tracking and activity detection by feature extractor 120.

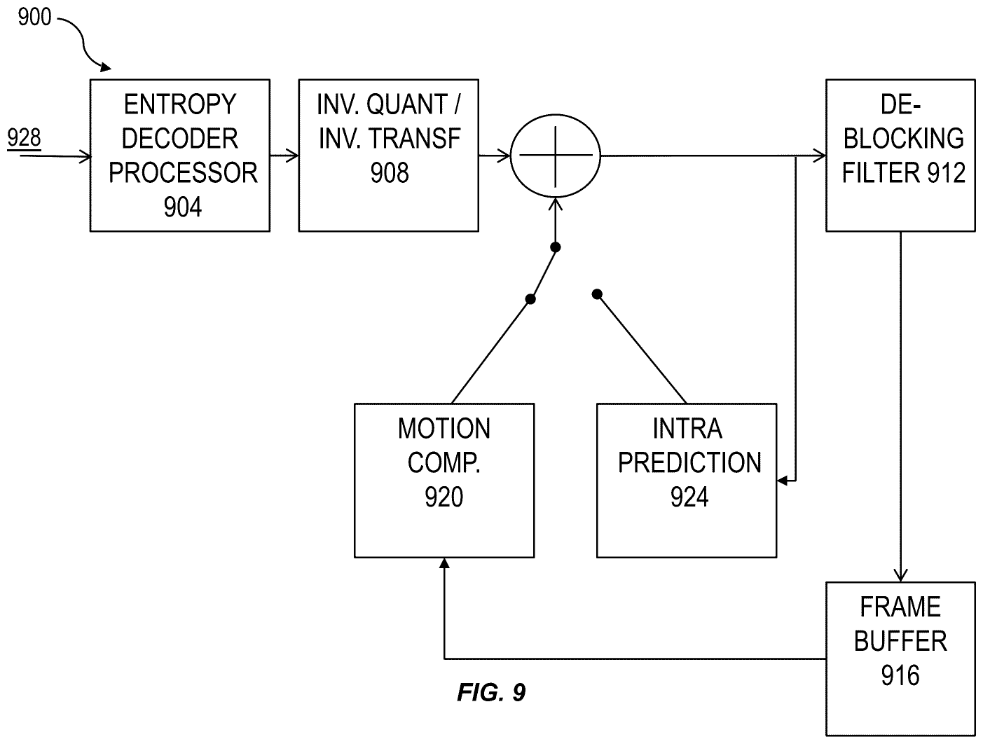

FIG. 9 is a system block diagram illustrating an example decoder, which may be suitable for implementing video decoder 144 and/or feature decoder 148 to decode video and features from the compressed hybrid bitstream. Decoder 900 may include an entropy decoder processor 904, an inverse quantization and inverse transformation processor 908, a deblocking filter 912, a frame buffer 916, a motion compensation processor 920 and/or an intra prediction processor 924.

In operation, and still referring to FIG. 9, bit stream 928 may be received by decoder 900 and input to entropy decoder processor 904, which may entropy decode portions of bit stream into quantized coefficients. Quantized coefficients may be provided to inverse quantization and inverse transformation processor 908, which may perform inverse quantization and inverse transformation to create a residual signal, which may be added to an output of motion compensation processor 920 or intra prediction processor 924 according to a processing mode. An output of the motion compensation processor 920 and intra prediction processor 924 may include a block prediction based on a previously decoded block. A sum of prediction and residual may be processed by deblocking filter 912 and stored in a frame buffer 916.

In an embodiment, and still referring to FIG. 9 decoder 900 may include circuitry configured to implement any operations as described above in any embodiment as described above, in any order and with any degree of repetition. For instance, decoder 900 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Decoder may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

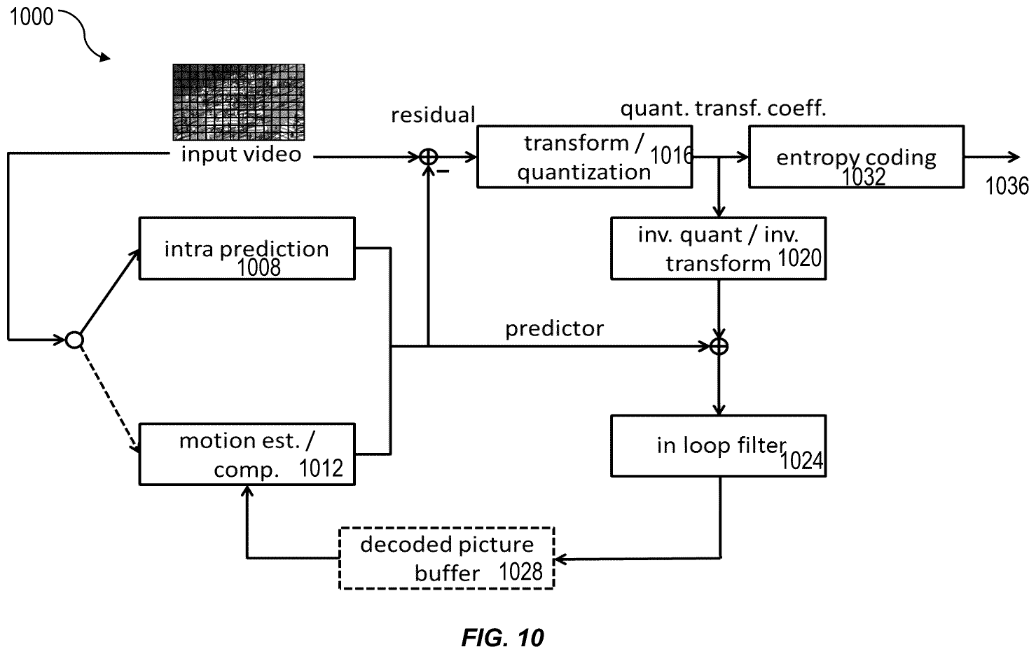

FIG. 10 is a system block diagram illustrating an example video encoder 116 1000 capable of adaptive cropping. Example video encoder 116 1000 may receive an input video 104 1004, which may be initially segmented or dividing according to a processing scheme, such as a tree-structured macro block partitioning scheme (e.g., quad-tree plus binary tree). An example of a tree-structured macro block partitioning scheme may include partitioning a picture frame into large block elements called coding tree units (CTU). In some implementations, each CTU may be further partitioned one or more times into a number of sub-blocks called coding units (CU). A final result of this portioning may include a group of sub-blocks that may be called predictive units (PU). Transform units (TU) may also be utilized.

Still referring to FIG. 10, example video encoder 116 1000 may include an intra prediction processor 1008, a motion estimation/compensation processor 1012, which may also be referred to as an inter prediction processor, capable of constructing a motion vector candidate list including adding a global motion vector candidate to the motion vector candidate list, a transform/quantization processor 1016, an inverse quantization/inverse transform processor 1020, an in-loop filter 1024, a decoded picture buffer 1028, and/or an entropy coding processor 1032. Bit stream parameters may be input to the entropy coding processor 1032 for inclusion in the output bit stream 1036.

In operation, and with continued reference to FIG. 10, for each block of a frame of input video 104 1004, whether to process block via intra picture prediction or using motion estimation/compensation may be determined. Block may be provided to intra prediction processor 1008 or motion estimation/compensation processor 1012. If block is to be processed via intra prediction, intra prediction processor 1008 may perform processing to output a predictor. If block is to be processed via motion estimation/compensation, motion estimation/compensation processor 1012 may perform processing including constructing a motion vector candidate list including adding a global motion vector candidate to the motion vector candidate list, if applicable.

Further referring to FIG. 10, a residual may be formed by subtracting a predictor from input video 104. Residual may be received by transform/quantization processor 1016, which may perform transformation processing (e.g., discrete cosine transform (DCT)) to produce coefficients, which may be quantized. Quantized coefficients and any associated signaling information may be provided to entropy coding processor 1032 for entropy encoding and inclusion in output bit stream 1036. Entropy encoding processor 1032 may support encoding of signaling information related to encoding a current block. In addition, quantized coefficients may be provided to inverse quantization/inverse transformation processor 1020, which may reproduce pixels, which may be combined with a predictor and processed by in loop filter 1024, an output of which may be stored in decoded picture buffer 1028 for use by motion estimation/compensation processor 1012 that is capable of constructing a motion vector candidate list including adding a global motion vector candidate to the motion vector candidate list.

With continued reference to FIG. 10, although a few variations have been described in detail above, other modifications or additions are possible. For example, in some implementations, current blocks may include any symmetric blocks (8×8, 16×16, 32×32, 64×64, 128×128, and the like) as well as any asymmetric block (8×4, 16×8, and the like).

In some implementations, and still referring to FIG. 10, a quadtree plus binary decision tree (QTBT) may be implemented. In QTBT, at a Coding Tree Unit level, partition parameters of QTBT may be dynamically derived to adapt to local characteristics without transmitting any overhead. Subsequently, at a Coding Unit level, a joint-classifier decision tree structure may eliminate unnecessary iterations and control the risk of false prediction. In some implementations, LTR frame block update mode may be available as an additional option available at every leaf node of QTBT.

In some implementations, and still referring to FIG. 10, additional syntax elements may be signaled at different hierarchy levels of bitstream. For example, a flag may be enabled for an entire sequence by including an enable flag coded in a Sequence Parameter Set (SPS). Further, a CTU flag may be coded at a coding tree unit (CTU) level.

Some embodiments may include non-transitory computer program products (i.e., physically embodied computer program products) that store instructions, which when executed by one or more data processors of one or more computing systems, cause at least one data processor to perform operations herein.

Still referring to FIG. 10, encoder 1000 may include circuitry configured to implement any operations as described above in any embodiment, in any order and with any degree of repetition. For instance, encoder 1000 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Encoder 1000 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 10, non-transitory computer program products (i.e., physically embodied computer program products) may store instructions, which when executed by one or more data processors of one or more computing systems, causes at least one data processor to perform operations, and/or steps thereof described in this disclosure, including without limitation any operations described above and/or any operations decoder 900 and/or encoder 1000 may be configured to perform Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, or the like.

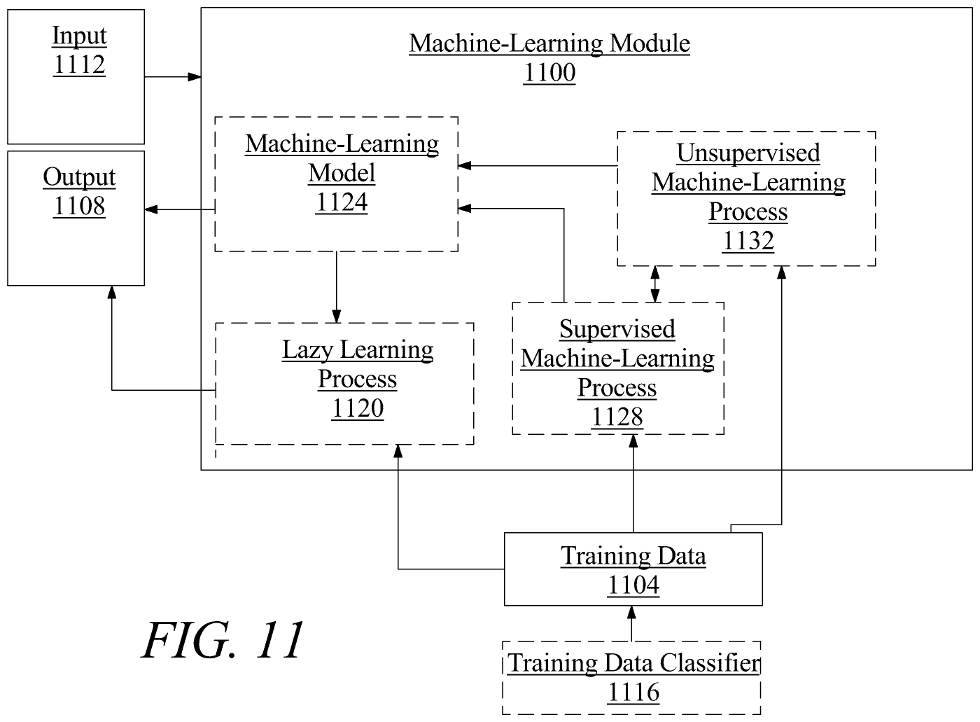

Referring now to FIG. 11, an exemplary embodiment of a machine-learning module 1100 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 1104 to generate an algorithm that will be performed by a computing device/module to produce outputs 1108 given data provided as inputs 1112, This is in contrast to a non-machine learning software program where the commands to be executed are generally determined in advance by a user and written in a programming language.

Still referring to FIG. 11, “training data,” as used herein, is data containing correlations that a machine-learning process may use to model relationships between two or more categories of data elements. For instance, and without limitation, training data 1104 may include a plurality of data entries, each entry representing a set of data elements that were recorded, received, and/or generated together; data elements may be correlated by shared existence in a given data entry, by proximity in a given data entry, or the like. Multiple data entries in training data 1104 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 1104 according to various correlations; correlations may indicate causative and/or predictive links between categories of data elements, which may be modeled as relationships such as mathematical relationships by machine-learning processes as described in further detail below. Training data 1104 may be formatted and/or organized by categories of data elements, for instance by associating data elements with one or more descriptors corresponding to categories of data elements. As a non-limiting example, training data 1104 may include data entered in standardized forms by persons or processes, such that entry of a given data element in a given field in a form may be mapped to one or more descriptors of categories. Elements in training data 1104 may be linked to descriptors of categories by tags, tokens, or other data elements; for instance, and without limitation, training data 1104 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 11, training data 1104 may include one or more elements that are not categorized; that is, training data 1104 may not be formatted or contain descriptors for some elements of data. Machine-learning algorithms and/or other processes may sort training data 1104 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 1104 to be made applicable for two or more distinct machine-learning algorithms as described in further detail below. Training data 1104 used by machine-learning module 1100 may correlate any input data as described in this disclosure to any output data as described in this disclosure.

Further referring to FIG. 11, training data may be filtered, sorted, and/or selected using one or more supervised and/or unsupervised machine-learning processes and/or models as described in further detail below; such models may include without limitation a training data classifier 1116. Training data classifier 1116 may include a “classifier,” which as used in this disclosure is a machine-learning model as defined below, such as a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. Machine-learning module 1100 may generate a classifier using a classification algorithm, defined as a process whereby a computing device and/or any module and/or component operating thereon derives a classifier from training data 1104.

Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers.

Still referring to FIG. 11, machine-learning module 1100 may be configured to perform a lazy-learning process 1120 and/or protocol, which may alternatively be referred to as a “lazy loading” or “call-when-needed” process and/or protocol, and may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 1104. Heuristic may include selecting some number of highest-ranking associations and/or training data 1104 elements. Lazy learning may implement any suitable lazy learning algorithm, including without limitation a k-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 11, machine-learning processes as described in this disclosure may be used to generate machine-learning models 1124. A “machine-learning model,” as used in this disclosure, is a mathematical and/or algorithmic representation of a relationship between inputs and outputs, as generated using any machine-learning process including without limitation any process as described above, and stored in memory; an input is submitted to a machine-learning model 1124 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 1124 may be generated by creating an artificial neural network, such as a convolutional neural network comprising an input layer of nodes, one or more intermediate layers, and an output layer of nodes. Connections between nodes may be created via the process of “training” the network, in which elements from a training data 1104 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 11, machine-learning algorithms may include at least a supervised machine-learning process 1128. At least a supervised machine-learning process 1128, as defined herein, include algorithms that receive a training set relating a number of inputs to a number of outputs, and seek to find one or more mathematical relations relating inputs to outputs, where each of the one or more mathematical relations is optimal according to some criterion specified to the algorithm using some scoring function. For instance, a supervised learning algorithm may include inputs as described in this disclosure as inputs, outputs as described in this disclosure as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 1104. Persons skilled in the art, upon reviewing the entirety of this disclosure, will be aware of various possible variations of at least a supervised machine-learning process 1128 that may be used to determine relation between inputs and outputs. Supervised machine-learning processes may include classification algorithms as defined above.

Further referring to FIG. 11, machine learning processes may include at least an unsupervised machine-learning processes 1132. An unsupervised machine-learning process, as used herein, is a process that derives inferences in datasets without regard to labels; as a result, an unsupervised machine-learning process may be free to discover any structure, relationship, and/or correlation provided in the data. Unsupervised processes may not require a response variable; unsupervised processes may be used to find interesting patterns and/or inferences between variables, to determine a degree of correlation between two or more variables, or the like.

Still referring to FIG. 11, machine-learning module 1100 may be designed and configured to create a machine-learning model 1124 using techniques for development of linear regression models. Linear regression models may include ordinary least squares regression, which aims to minimize the square of the difference between predicted outcomes and actual outcomes according to an appropriate norm for measuring such a difference (e.g., a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 11, machine-learning algorithms may include, without limitation, linear discriminant analysis. Machine-learning algorithm may include quadratic discriminate analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized tress, AdaBoost, gradient tree boosting, and/or voting classifier methods. Machine-learning algorithms may include neural net algorithms, including convolutional neural net processes.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random-access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

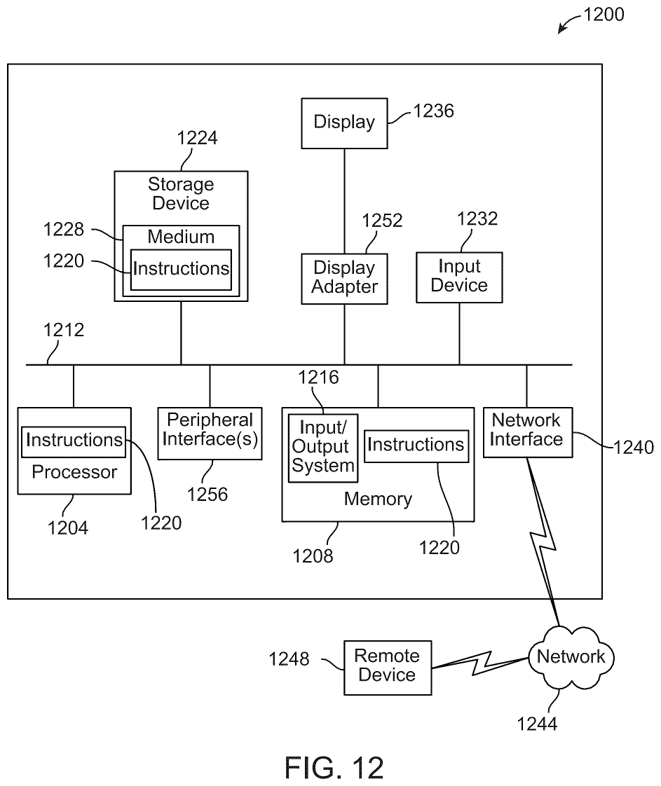

FIG. 12 shows a diagrammatic representation of one embodiment of a computing device in the exemplary form of a computer system 1200 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1200 includes a processor 1204 and a memory 1208 that communicate with each other, and with other components, via a bus 1212. Bus 1212 may include any of several types of bus structures including, but not limited to, a memory bus, a memory controller, a peripheral bus, a local bus, and any combinations thereof, using any of a variety of bus architectures.

Processor 1204 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 1204 may be organized according to Von Neumann and/or Harvard architecture as a non-limiting example. Processor 1204 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating-point unit (FPU), and/or system on a chip (SoC).

Memory 1208 may include various components (e.g., machine-readable media) including, but not limited to, a random-access memory component, a read only component, and any combinations thereof. In one example, a basic input/output system 1216 (BIOS), including basic routines that help to transfer information between elements within computer system 1200, such as during start-up, may be stored in memory 1208. Memory 1208 may also include (e.g., stored on one or more machine-readable media) instructions (e.g., software) 1220 embodying any one or more of the aspects and/or methodologies of the present disclosure. In another example, memory 1208 may further include any number of program modules including, but not limited to, an operating system, one or more application programs, other program modules, program data, and any combinations thereof.

Computer system 1200 may also include a storage device 1224. Examples of a storage device (e.g., storage device 1224) include, but are not limited to, a hard disk drive, a magnetic disk drive, an optical disc drive in combination with an optical medium, a solid-state memory device, and any combinations thereof. Storage device 1224 may be connected to bus 1212 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1224 (or one or more components thereof) may be removably interfaced with computer system 1200 (e.g., via an external port connector (not shown)). Particularly, storage device 1224 and an associated machine-readable medium 1228 may provide nonvolatile and/or volatile storage of machine-readable instructions, data structures, program modules, and/or other data for computer system 1200. In one example, software 1220 may reside, completely or partially, within machine-readable medium 1228. In another example, software 1220 may reside, completely or partially, within processor 1204.

Computer system 1200 may also include an input device 1232. In one example, a user of computer system 1200 may enter commands and/or other information into computer system 1200 via input device 1232. Examples of an input device 1232 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1232 may be interfaced to bus 1212 via any of a variety of interfaces (not shown) including, but not limited to, a serial interface, a parallel interface, a game port, a USB interface, a FIREWIRE interface, a direct interface to bus 1212, and any combinations thereof. Input device 1232 may include a touch screen interface that may be a part of or separate from display 1236, discussed further below. Input device 1232 may be utilized as a user selection device for selecting one or more graphical representations in a graphical interface as described above.

A user may also input commands and/or other information to computer system 1200 via storage device 1224 (e.g., a removable disk drive, a flash drive, etc.) and/or network interface device 1240. A network interface device, such as network interface device 1240, may be utilized for connecting computer system 1200 to one or more of a variety of networks, such as network 1244, and one or more remote devices 1248 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1244, may employ a wired and/or a wireless mode of communication. In general, any network topology may be used. Information (e.g., data, software 1220, etc.) may be communicated to and/or from computer system 1200 via network interface device 1240. Computer system 1200 may further include a video display adapter 1252 for communicating a displayable image to a display device, such as display device 1236. Examples of a display device include, but are not limited to, a liquid crystal display (LCD), a cathode ray tube (CRT), a plasma display, a light emitting diode (LED) display, and any combinations thereof.

Display adapter 1252 and display device 1236 may be utilized in combination with processor 1204 to provide graphical representations of aspects of the present disclosure. In addition to a display device, computer system 1200 may include one or more other peripheral output devices including, but not limited to, an audio speaker, a printer, and any combinations thereof. Such peripheral output devices may be connected to bus 1212 via a peripheral interface 1256. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A video coding for machines (VCM) encoder, the VCM encoder comprising:
a first video encoder, the first video encoder configured to encode an input video into a bitstream;
a feature extractor, the feature extractor configured to detect at least a feature in the input video; and
a second encoder, the second encoder configured to encode a feature bitstream as a function of the input video and at least a feature.

2. The VCM encoder of claim 1, wherein the feature extractor further comprises a machine-learning model configured to output at least a feature map.

3. The VCM encoder of claim 2, wherein the machine-learning model further comprises a convolutional neural network.

4. The VCM encoder of claim 3, wherein the convolutional neural network include: a plurality of convolutional layers; and
a plurality of pooling layers.

5. The VCM encoder of claim 2, wherein the feature extractor further comprises a classifier, the classifier configured to classify an output of the machine-learning model to at least a feature.

6. The VCM encoder of claim 5, wherein the classifier further comprises a deep neural network.

7. The VCM encoder of claim 5, wherein the second encoder is further configured to group feature maps of the at least a feature map according to a classification to at least a feature.

8. The VCM encoder of claim 1, wherein the second encoder further comprises a feature encoder.

9. The VCM encoder of claim 1, wherein the second encoder further comprises a video encoder.

10. The VCM encoder of claim 1, wherein the first video encoder is coupled to the feature extractor and receives a feature signal therefrom.

11. The VCM encoder of claim 1 further comprising a multiplexor, the multiplexor configured to combine the video bitstream and the feature bitstream.

12. The VCM encoder of claim 1, wherein the feature extractor is configured to generate a plurality of feature maps and wherein the feature maps are spatially arranged prior to encoding.

13. The VCM encoder of claim 12, wherein the feature maps are spatially arranged based at least in part on a texture component of the feature maps.

14. A VCM decoder configured to receive an encoded hybrid bitstream, the decoder comprising:
a demultiplexor receiving the hybrid bitstream;
a feature decoder, the feature decoder receiving an encoded feature bitstream from the demultiplexor and providing a decoded set of features for machine processing;
a machine model couple to the feature decoder; and
a video decoder, the video decoder receiving an encoded video bitstream from the demultiplexor and providing a decoded video signal for human consumption.

15. The VCM decoder of claim 14, wherein the feature decoder is configured to receive a bitstream comprising a plurality of spatially arranged feature maps, decode the spatially arranged feature maps, and reconstruct the original sequence of feature maps.
